(19) United States
(12) Patent Application Publication
(10) Pub. No.: US 2026/0252322 A1
(43) Pub. Date: Aug. 27, 2026

(54) METHOD AND APPARATUS FOR PROGRAMMING

(71) Applicant: Huawei Cloud Computing Technologies Co., Ltd., Guizhou (CN)

(72) Inventors: Sergey Valerievich KOVALCHUK, Saint Petersburg (RU); Artem Aliev, Saint Petersburg (RU); Vadim Lomshakov, Saint Petersburg (RU); Kang Hu, Shenzhen (CN)

(73) Assignee: Huawei Cloud Computing Technologies Co., Ltd., Guizhou (CN)

(21) Appl. No.: 19/649,542

(22) Filed: Apr. 16, 2026

Related U.S. Application Data
(63) Continuation of application No. PCT/CN2024/089328, filed on Apr. 23, 2024.

(30) Foreign Application Priority Data
Oct. 20, 2023 (WO) PCT/RU2023/000317

(51) Int. Cl. G06F 8/35; G06F 16/335

(52) U.S. Cl. CPC G06F 8/35; G06F 16/337

(57) ABSTRACT

This disclosure provides a method and an apparatus for programming. The method includes: identifying a first target profile from a set of profiles according to information related to a target user. The set of profiles is obtained according to information related to users, and each profile in the set of profiles corresponds to a category of the information related to the users. The method further includes determining one or more candidate models from a model database according to the first target profile. The models in the model database are trained models obtained through subsets of a training dataset. The models are used for programming tasks. The subsets are obtained by dividing the training dataset based on the set of profiles. The method further includes obtaining a target action from one or more candidate actions generated by applying the one or more candidate models to context.

### CROSS-REFERENCE TO RELATED APPLICATIONS

This application is a continuation of International Application No. PCT/CN2024/089328, filed on Apr. 23, 2024, which claims priority to International Application No. PCT/RU2023/000317, filed on Oct. 20, 2023. The disclosures of the aforementioned applications are hereby incorporated by reference in their entireties.

The disclosure of the aforementioned application is hereby incorporated by reference in its entirety.

### TECHNICAL FIELD

Embodiments of this disclosure relate to the field of programming, and more specifically, to a method and an apparatus for programming.

### BACKGROUND

Artificial intelligence (AI) models have been integrated into the software development process, thus changing coding methods through significant automation of code generation, analysis, and modification. Most pretrained language models (PLMs) which are commonly used as a backbone in relevant technical solutions are trained and deployed as copycat for general human developer using large datasets which reflect experience of different developers in different contexts.

However, in the relevant technical solutions, it is difficult to provide personalized services for developers, which affects the development experience of the developers.

Therefore, an urgent technical problem that needs to be solved is how to provide personalized services for developers.

### SUMMARY

Embodiments of this disclosure provide a method and an apparatus for programming. The technical solutions may provide personalized services for developers.

According to a first aspect, an embodiment of this disclosure provides a method for programming, including: identifying a first target profile from a set of profiles according to information related to a target user, where the set of profiles is obtained according to information related to users, and each profile in the set of profiles corresponds to a category of the information related to the users; determining one or more candidate models from a model database according to the first target profile, where models in the model database are trained models obtained through subsets of a training dataset, the models are used for programming tasks, and the subsets are obtained by dividing the training dataset based on the set of profiles; and obtaining a target action from one or more candidate actions generated by applying the one or more candidate models to context.

According to the above technical solution, the models stored in the model database are trained models obtained through subsets, and the subsets are obtained based on the set of profiles. Therefore, the models in the model database may be understood as models trained separately for each profile. After identifying the profile corresponding to the user, the one or more candidate models can be determined from the model database based on the profile. In other words, personalized model selection is provided in the embodiments of this disclosure. In this way, the one or more candidate models may be more suitable for the user, which is conducive to providing output that matches the user in the context, and providing personalized support for the user.

For example, the target user can be the current user who is currently programming in software development.

Exemplarily, the set of profiles may be obtained through a rule-based approach based on the information related to the users, which means the set of profiles may be obtained according to rule(s).

Alternatively, the set of profile may be obtained through clustering based on the information related to the users.

In some embodiments, profiles in the set of profiles are organized in sequence which is used to represent professional growth of a user.

The profiles may be organized according to the professional growth of a user.

According to the above technical solution, the profiles may be organized in sequence representing the professional trajectory, which is conducive to providing professional growth support for users at different professional levels and further improving the user experience.

In some embodiments, the one or more candidate models may be from the model(s) corresponding to one or more target profiles in the model database. The one or more target profiles may include two profiles: the first target profile and a second target profile. The first target profile and the second target profile may be the two profiles in the set of profiles that are most similar to the information related to the target user.

In some embodiments, in the set of profiles, a distance between the first target profile and the information related to the target user is the smallest.

According to the above technical solution, the first target profile may be understood as the profile that is most relevant to the target user. In the case that the profiles in the set of profiles are organized in sequence which is used to represent professional growth of a user, the first target profile may be understood as the profile that matches the target user's professional level. This is conducive to providing professional growth support for a user based on the user's current professional level and further improving the user experience.

In some embodiments, the one or more candidate models include one or more first models and one or more second models. The one or more first models are trained models obtained using one or more subsets in the subsets of the training dataset corresponding to the first target profile. The one or more second models are trained models obtained using one or more subsets in the subsets of the training dataset corresponding to a second target profile. The second target profile is a next profile of the first target profile in the sequence.

According to the above technical solution, the second model(s) corresponding to the second target profile may be involved in the generation process of the target output, where the second target profile may be the next profile of the first target profile that may match the target user based on the professional trajectory. The first target profile may be understood as the profile that best matches the target user's professional level, while the second target profile may be understood as the profile of the target user's higher level of professional. When the second model(s) corresponding to the second target profile are involved in determining the target output, that is, the user is pushed towards higher-level profile along the professional trajectory, which may stimulate the professional growth of the user.

In some embodiments, the one or more first models and the one or more second models are integrated to obtain one or more weighted ensemble models, and the one or more weighted ensemble models are used to generate the one or more candidate actions.

According to the above technical solution, the or more first models and the one or more second models may be integrated to obtain the ensemble model which is used to determine the target output. This is conducive to providing corresponding support for users at different professional levels while promoting the professional growth, thereby further improving the user experience.

In some embodiments, weights for the one or more first models and the one or more second models are positively correlated with distances between the first and second target profiles and the information related to the target user.

In some embodiments, the information related to the users includes at least one of following: users' personal information, users' text bases, users' code bases, users' repository activities, results of a questionnaire for identifying users' profiles, or users' states in integrated development environment.

In some embodiments, the context is obtained according to at least one of following: editing position, project, source file, or code graph.

According to a second aspect, an embodiment of this disclosure provides an apparatus for programming, including: an identification module, configured to identify a first target profile from a set of profiles according to information related to a target user, where the set of profiles is obtained according to information related to users, and each profile in the set of profiles corresponds to a category of the information related to the users; a determining module, configured to determine one or more candidate models from a model database according to the first target profile, where models in the model database are trained models obtained through subsets of a training dataset, the models are used for programming tasks, and the subsets are obtained by dividing the training dataset based on the set of profiles; and an obtaining module, configured to obtain a target action from one or more candidate actions generated by applying the one or more candidate models to context.

In some embodiments, profiles in the set of profiles are organized in sequence which is used to represent professional growth of a user.

In some embodiments, the one or more candidate models include one or more first models and one or more second models. The one or more first models are trained models obtained using one or more subsets in the subsets of the training dataset corresponding to the first target profile. The one or more second models are trained models obtained using one or more subsets in the subsets of the training dataset corresponding to a second target profile. The second target profile is a next profile of the first target profile in the sequence.

In some embodiments, the one or more first models and the one or more second models are integrated to obtain one or more weighted ensemble models, and the one or more weighted ensemble models are used to generate the one or more candidate actions.

In some embodiments, weights for the one or more first models and the one or more second models are positively correlated with distances between the first and second target profiles and the information related to the target user.

In some embodiments, in the set of profiles, a distance between the first target profile and the information related to the target user is the smallest.

In some embodiments, the information related to the users includes at least one of following: users' personal information, users' text bases, users' code bases, users' repository activities, results of a questionnaire for identifying users' profiles, or users' states in integrated development environment.

In some embodiments, the context is obtained according to at least one of following: editing position, project, source file, or code graph.

According to a third aspect, a computing device cluster is provided, including at least one computing device, where each computing device includes a processor and a memory. The processor of the at least one computing device is configured to execute instructions stored in the memory of the at least one computing device, so that the computing device cluster performs the method in any one of the first aspect or the examples of the first aspect.

According to a fourth aspect, a computer-readable storage medium is provided, including one or more instructions. When the one or more instructions are executed by a computing device cluster, the computing device cluster performs the method in any one of the first aspect or the examples of the first aspect.

According to a fifth aspect, a computer program product including instructions is provided, where when the instructions are executed by a computing device cluster, the computing device cluster performs the method in any one of the first aspect or the examples of the first aspect.

### DESCRIPTION OF DRAWINGS

FIG. 1 illustrates four integrated development environment (IDE) generations;

FIG. 2 is a schematic flowchart of a method for programming according to an embodiment of this disclosure;

FIG. 3 is a schematic flowchart of another method for programming according to an embodiment of this disclosure;

FIG. 4 is a schematic flowchart of a method for obtaining a model database according to an embodiment of this disclosure;

FIG. 5 is a schematic diagram of the overall processing flow in a pair programming scenario according to an embodiment of this disclosure; and

FIGS. 6-9 are schematic block diagrams of example devices according to embodiments of this disclosure.

### DESCRIPTION OF EMBODIMENTS

The following describes technical solutions of this disclosure with reference to the accompanying drawings.

In order to facilitate understanding of the embodiments of this disclosure, terms related to artificial intelligence (AI) or machine learning (ML) that may be involved in the embodiments of this disclosure are described below.

### (1) Pair Programming;

Pair programming is a software development technique where two programmers work with the same code simultaneously. In some scenarios, one developer may be represented by human while the other(s) are AI agents.

### (2) Personalization;

Personalization is a process of optimization of experience/communication/solution depending on personal characteristics of a user.

### (3) AI Alignment;

AI alignment is a problem of arranging AI towards human intended goals, values, preferences, ethics, etc. Here we consider AI alignment as a conceptual reference problem which may be answered by profile-based model control to avoid large language model (LLM) degradation and biases against true developer's goals.

### (4) AI/ML Model Training

AI/ML model training is a process to train an AI/ML Model by learning the input/output relationship in a data driven manner and obtain the trained AI/ML Model for inference.

### (5) AI/ML Model Inference

A process of using a trained AI/ML model to produce a set of outputs based on a set of inputs.

### (6) Supervised Learning

The goal of supervised learning algorithms is to train a model that maps feature vectors (inputs) to labels (output), based on the training data which includes the example feature-label pairs. The supervised learning can analyze the training data and produce an inferred function, which can be used for mapping the inference data.

AI models have been integrated into the software development process, thus changing coding methods through significant automation of code generation, analysis, and modification. Most AI solutions applicable in software engineering are based on deep learning approaches, such as LLMs.

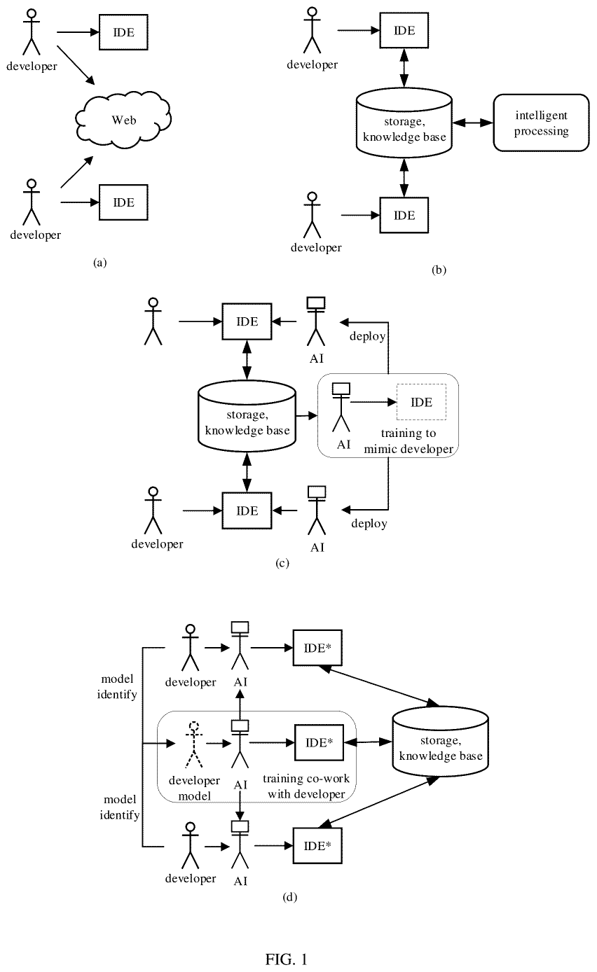

FIG. 1 shows four integrated development environment (IDE) generations.

The IDE in (a) of FIG. 1 can be called “classic” IDE. As shown in (a) of FIG. 1, the IDE considers local interaction of a developer with implicit knowledge acquisition via web and other sources. The IDE in (b) of FIG. 1 can be called integrated IDE (IDE 2.0). As shown in (b) of FIG. 1, IDE 2.0 provides interconnection with common knowledge base to share knowledge resources. The content stored in the common knowledge base may be obtained through intelligent processing. The IDE in (c) of FIG. 1 can be referred to as AI-empowered IDE. AI agents (usually as plugins for IDEs) have been introduced to mimic developers' activity in coding, such as code generation and code completion. As shown in (c) of FIG. 1, an AI model is trained to mimic a developer, and then the AI model is deployed as an AI agent. The IDE in (d) of FIG. 1 can be referred to as IDE for AI. The proposed solution in (d) of FIG. 1 focuses on building a novel way of interacting with IDE, delegating code development directly to AI in its own way. An AI agent becomes a proxy that can transform developer's requests into actual coding practices. As a proxy, the AI agent may introduce new ways of working with IDEs. Therefore, the AI agent is used to represent a human developer. The new type of IDE (“IDE*” in (d) of FIG. 1) aims to first meet the needs of the AI agent, in contrast to human-developer IDEs of previous generations. The appropriate AI model working as the AI agent used to cooperate with the developer may be selected based on the developer model. The appropriate AI model may be one or more candidate models in the embodiments of this disclosure. The developer model may be one or more target profiles in a set of profiles, such as a first target profile, and a second target profile, that are used to determine the candidate model(s). The process of model identification may refer to the identification process of profiles and the determination process of candidate models in the following text.

PLMs are commonly used as a backbone in the relevant solutions, which has made a significant breakthrough in many programming tasks. A common way to work with PLM is training and finetuning models using available datasets. There are still some limitations in personalization. For example, most PLMs in the relevant solutions are trained and deployed as copycat for general (averaged) human developers using large datasets which reflect experiences of different developers in different contexts, which causes two problems. Firstly, the PLMs are mimicking averaged human developers and propose solutions in the same way as the averaged human developers, which means that for one developer, the code provided by PLMs can be regarded as the code provided by others. This leads to an increase in interaction issues where the developer may need to spend a lot of effort understanding the code and integrating it into the development pipeline. Secondly, the PLMs often behave without proper understanding of a developer and project context, and provide an average most probable solution which may not match the developer's requirements. Therefore, in most cases, the solutions provided by PLMs tend to be rejected by developers or require significant effort from developers to be utilized.

On the other hand, total personalization and adaptation of a PLM is impractical for most cases as proper training and even finetuning of PLM require a large dataset. And the available data of a single developer is limited, which is not enough for a PLM. Using a limited and biased dataset of a single developer to obtain a model may lead to overfitting, which may result in degradation in performance even in single user interactions. Similarly, in most cases, the solutions provided by PLMs tend to be rejected by developers or require significant effort from developers to be utilized.

Therefore, an urgent technical problem that needs to be solved is how to provide personalized support for developers in programming tasks.

The embodiments of this disclosure provide a method for programming using profile-based AI integration, which can be applied to IDE, and is beneficial to providing personalized programming support for developers. For example, the embodiments of this disclosure bring personalization in PLM training and application to support developers in programming tasks.

The technical solutions in the embodiments of this disclosure can be applied to different programming tasks. The common transformation of two modalities (code and text) includes: code to code (C2C), code to text (C2T), text to code (T2C), and text to text (T2T). For example, C2C type task may be code repair or code completion. C2T type task may be code summary or code review. T2C type task may be question-answering (QA) with code or code generation. T2T type task may be QA.

Code generation is taken as an example. The technical solutions in the embodiments of this disclosure allow to provide personalized code snippets. For different developers, the technical solutions in the embodiments of this disclosure may provide different code snippets to be generated. For example, a junior developer may need more step-by-step examples of solving a task, while a senior developer may need only references and examples of particular application programming interface (API).

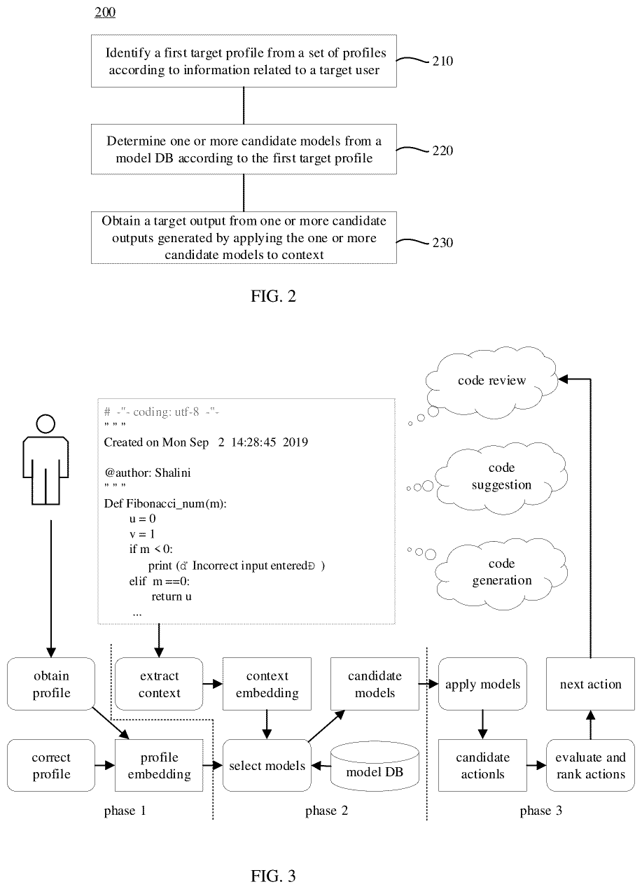

FIG. 2 is a schematic flowchart of a method 200 for programming. The method 200 can be used to provide programming task support.

The method 200 can be applied to IDE. For example, the method 200 may be applied to IDE in a form that supports extensions, such as in the form of plugins.

As shown in FIG. 2, the method 200 may include the following operations.

In operation 210, a first target profile is identified from a set of profiles according to information related to a target user.

The set of profiles is obtained according to information related to users. Each profile in the set of profiles corresponds to a category of the information related to the users.

In operation 220, one or more candidate models are determined from a model database (DB) according to the first target profile. The models in the model database are trained models obtained through subsets of a training dataset. The subsets of the training dataset are obtained by dividing the training dataset based on the set of profiles. The models are used for programming tasks. Or the models are used to provide program support.

In operation 230, a target output is obtained from one or more candidate outputs generated by applying the one or more candidate models to context.

According to the technical solutions in the embodiments of this disclosure, the models stored in the model database are trained models obtained through subsets, and the subsets are obtained based on the set of profiles. Therefore, the models in the model database may be understood as models trained separately for each profile. After identifying the profile corresponding to the user, the one or more candidate models can be determined from the model database based on the profile. In other words, personalized model selection is provided in the embodiments of this disclosure. In this way, the one or more candidate models may be more suitable for the user, which is conducive to providing output that matches the user in the context, and providing personalized support for the user.

Meanwhile, the models in the model database are trained models obtained through subsets. A profile may be applicable to a plurality of users. In this way, one subset may include training data related to a plurality of users, rather than just training data related to one user, which is beneficial to avoiding the poor performance of the trained model caused by a small amount of personal data or biased personal data, such as overfitting.

What's more, the set of profiles may be adjusted as needed, which is conductive to improving the flexibility, scalability and adaptability of the solution. At the same time, the subsets may be controllable around the profiles, which is conductive to avoiding performance degradation caused by the overfitting to certain scenarios and contexts.

In addition, the subsets of training data are obtained based on the set of profiles. The consistency of training data in one subset corresponding to the same profile may be relatively high, which is conducive to stabilizing the behavior of the trained model.

The user can also be referred to as a developer.

For example, the target user can be the current user who is currently programming in software development.

The first target profile may be understood as the profile in the set of the profiles that corresponds to the target user. A profile corresponding to a user may also be understood as the user appearing in the profile. Or the information related to the user appears in the profile.

The “first” in “first target profile” is only used to illustrate that the profile corresponds to the target user and does not have any other limiting effect.

As mentioned before, the set of profiles may be obtained based on the information related to the users. The target user may or may not belong to the users.

The information related to the users may be divided into multiple groups or categories, with each group or category corresponding to one profile. For example, if information #A and information #B are similar, the information #A and the information #B may be divided into the same group, corresponding to the same profile.

The information related to a user may also be referred to as user-specific information. The information related to the user may include at least one of the following: user's personal information, a user's text base, a user's code base, a user's repository activities, a result of a questionnaire for identifying a user's profile provided by the user, or a user's state in IDE.

The personal information may be referred to as personal characteristics or explicit profile data.

For example, the profile data may be the profile data in a corporate information system.

For example, the personal information may include at least one of the following: grade, position, scientific degree, area of expertise, technology stack, or team.

The grade, position, or scientific degree may be collectively referred to as a level in the embodiments of this disclosure. The level of a developer may be considered to be a sequential scale of developer maturity.

For example, a user's grade may be a user's employee grade determined by an employer or a user's internal grade in the company.

For example, a user's position may include junior, middle, senior, or leader.

The above is only an example, the level may also include other types, such as the internal expertise level within a company. The embodiment of this disclosure does not limit this.

The area of expertise, technology stack and team may be collectively referred to as a role in the embodiments of this disclosure. The role of a developer may be defined as a common scenario of acting in a project, a set of tasks, and distribution of responsibilities.

For example, the area of expertise where a user belongs may include a front-end developer, a back-end developer, a DB expert, a web developer, an internet of things (IoT) developer, a machine learning (ML) engineer, a data scientist, etc.

For example, a user's code base may include at least one of code, a set of used libraries, programming language, or code style.

For example, a user's repository activities may include at least one of the following: commits, pull requests (PRs), comments, or reviews. Alternatively, the comments and the reviews may be considered as belonging to the user's text base. The commits and pull requests may be considered as belonging to the user's code base.

A user's state in IDE may include cognitive state and/or activity state, such as writing code, exploring documentation, thinking, or debugging.

In addition, the information related to the user may include information related to the user in one or more periods. The information related to the user in different periods may correspond to different profiles, which means that the user may appear in different profiles, or the user in different periods may correspond to different profiles.

The set of profiles can be obtained in multiple ways.

Exemplarily, the set of profiles may be obtained through a rule-based approach based on the information related to the users, which means the set of profiles may be obtained according to rule(s).

The user's grade is taken as an example.

For example, one profile may correspond to one grade. The information related to the users with the same grade may correspond to the same profile. The profile may include the grade corresponding to the profile.

The user's grade and area of expertise where the user belongs are taken as an example.

For example, one profile may correspond to one grade-area of expertise pair. The information related to the users with the same grade and area of expertise may correspond to the same profile. The profile may include the grade and the area of expertise corresponding to the profile. The profile may be expressed as <grade, area of expertise>.

The user's position and technology stack are taken as an example.

For example, one profile may correspond to one position-technology stack pair. The information related to the users with the same position and technology stack may correspond to the same profile. The profile may include the position and the technology stack corresponding to the profile. The profile may be expressed as <position, technology stack>.

Alternatively, the set of profile may be obtained through clustering based on the information related to the users.

Exemplarily, the information related to the users is clustered to obtain a plurality of clusters. Each cluster may correspond to one profile.

Also, profiles may be defined after clustering and cluster interpretation (e.g. filtering and ranking of clusters). For example, the information related to the users is clustered to obtain a plurality of clusters, and the clusters are filtered and sorted. Each cluster in the filtered and sorted clusters may correspond to one profile.

As an example, a profile may be the center of the cluster corresponding to the profile.

The user's personal information is taken as an example. The personal information related to the users is clustered to obtain a plurality of clusters. For example, the closer the following items are, the higher the likelihood of the personal information related to the users being divided into the same cluster: position, scientific degree, and team is.

The user's code base is taken as an example. The code bases of a plurality of users are clustered to obtain a plurality of clusters. For example, the closer the following items are, the higher the likelihood of personal information related to the users being divided into the same cluster: programming language, coding style, and set of used libraries is.

The above is only an example and does not constitute a limitation on the technical solutions in the embodiment of this disclosure. The clustering object can also be one or more of the information related to the users mentioned above.

The set of profiles may be predefined.

Further, the profiles in the set of profiles may be encoded as embeddings in a linear space, which may be called a profile space.

The profile space may also be called a personal embedding space.

A profile may be encoded as a multi-dimensional embedding or a one-dimensional embedding.

In some embodiments, the profiles in the set of profiles may be organized in sequence.

The sequence may be used to represent professional growth of a user, which is interpreted as “professional trajectory” or “career trajectory”. In other words, the profiles may be organized according to the professional growth of a user. In this case, the profile space may also be called a personal level space. The professional trajectory may be considered as a sequence of states.

The sequence may be set in a plurality of ways.

For example, the sequence may be determined manually. In other words, the order of the profiles may be determined by human.

For another example, the sequence may be set according to a rule, such as internal grades in the company or the position.

For another example, the sequence may be determined according to the analysis of the users' career.

As mentioned before, a user may appear in several profiles, or to say, a user in several periods may corresponds to several profiles. When these profiles are arranged in order based on the user's several periods, the order of these profiles can be considered as a pattern. If this pattern repeats among multiple users, then the order of these profiles may be determined.

The first target profile may also be called an identified profile.

The following describes identifying the first target profile.

The first target profile may be identified according to the characteristics of the target user. The characteristics of the target user may be obtained from the information related to the target user.

For example, the information related to the target user may include at least one of the following: target user's personal information, a target user's text base, a target user's code base, target user's repository activities, a result of a questionnaire for identifying a first target profile provided by the target user, or a target user's state in IDE.

The profile in a set of profiles that is most relevant to the characteristics of the target user may be the first target profile. Or the first target profile may be the profile that is most similar to the information related to the target user. Or in the set of profiles, the similarity between the first target profile and the information related to the target user is the highest. The similarity may be replaced with a distance metric (e.g. in Euclidean distance). The distance metric between the two may be used to measure the degree of closeness between them. For example, the smaller the distance between the two is, the closer they are. In the set of profiles, the distance between the first target profile and the information related to the target user may be the smallest.

The information related to a user may be replaced with the user's profile. The user's profile may be understood as the actual profile obtained from the information related to the user. The user's profile may or may not belong to the set of the profiles. In this case, the first target profile may be the profile that is most similar to the user's profile.

The characteristics of the target user may be represented by an embedding, or the information related to the target user may be encoded to an embedding, which can be called a user embedding.

The user embedding and the profile embeddings are defined in the same space.

The first target profile may be identified according to the distance between the user embedding and profile embeddings defined in the same space.

For example, in comparison with other profiles in the set of profiles, the distance between the profile embedding of the first target profile and the user embedding may be the smallest.

As mentioned before, the target user may be the current user. In this case, the characteristics used to identify the first target profile can also be understood as the current characteristics of the user. In this way, the first target profile may be determined based on the current characteristics of the user.

The following describes the model database.

The model database is used to store a plurality of trained models or pretrained models. These models are PLMs used to output code-based actions or text-based actions for the programming tasks. The programming tasks may also be replaced with programming scenarios or modalities.

A trained model may be understood as a model that can be directly used for inference. A pretrained model may be directly used for inference, or it may require configuration or fine-tuning before it can be used for inference. A pretrained model (such as UnixCoder, CodeLlama, etc.) may be configured or finetuned for different tasks with configuration, or finetuning on different datasets.

For the convenience of description, in the embodiments of this disclosure, the model database storing the trained models is taken as an example. The models in the model DB may be used to be applied to the same or different programming tasks.

For example, the programming tasks may include code review and code completion. There may be models for code completion and models used for code review in the model DB. The action provided by the models for code completion may be generating one or more lines of code. The models for code completion may be used to complete the next line or several lines of code based on the input code snippet. The action provided by the models for code review may be generating comments. The models for code review may be used to output comments on the current code.

The information related to the user may further include the programming task provided for the user.

The training dataset includes multiple training data. The training data in the training dataset is split into subsets according to the profiles in the set of profiles. Models may be trained for predefined a set of actions using the subsets. Each type of action may correspond to one programming task. The types of actions in the set of actions may include at least one of code completion, code review, QA, etc. In other words, the models are trained for one or more programming tasks using the subsets. This training process may be referred to as profile-based model training.

A model used for a certain action type may be understood as a model used to provide this type of the action. Or the type of the action generated by the model is this action type. The output of the model is the specific action, or in other words, the specific content of the action. For example, there may be a model used for code generation. The action type provided by the model is the action “code generation”. The output of the model may be the content of the action “code generation”. The content of the action “code generation” may be the generated code or token in the action “code generation”.

It can be seen that the output of the model may be a complete answer, such as the generated lines of code in the action “code generation”. The answer may also be replaced with solution. Or the output of the model may be intermediate results used to generate a complete answer, such as tokens during LLM-based generation.

The target output in operation 230 may also be replaced with the target action or next action. The target user may be the current user. The context may be the current context. In this case, the target action may also be understood as the next best action (NBA) in the current context for the current user.

The number of the subsets of the training dataset and the number of the profiles in the set of the profiles may be the same or different. One profile corresponds to at least one subset. Correspondingly, one profile corresponds to at least one model in the model DB. A model corresponding to a profile may refer to the model obtained through training using the subset corresponding to the profile. The “model obtained through training using the subset” here may be understood as a model trained using the subset from the beginning, or as a model fine-tuned on the subset. The embodiment of this disclosure is not limited to this.

The description of the training process can refer to the following text, and will not be described here.

The model database stores the model, which may include storing the model weights and/or running procedures of the model.

The models may be stored in the model database maintaining a link to the profile space.

The following describes how to determine the one or more candidate models and the target output.

In operation 220, the one or more candidate models may be from the model(s) corresponding to one or more target profiles in the model database. The one or more target profiles may include the first target profile and/or the profile determined based on the first target profile in the set of the profiles.

As an example, the one or more target profiles may include two profiles: the first target profile and a second target profile.

The “second” in “second target profile” is only used to illustrate the profile used to determine the one or more candidate models, other than the first target profile, and does not have any other limiting effect.

The second target profile may be selected in multiple ways.

Exemplarily, the first target profile and the second target profile may be the two profiles in the set of profiles that are most similar to the information related to the target user. The similarity between the first target profile and the information related to the target user is higher than that between the second target profile and the information related to the target user.

Alternatively, the second target profile may be selected according to the sequence of the profiles in the set of the profiles and the first target profile. In this case, the first target profile and the second target profile may be referred to as sequential profiles.

In some embodiments, the second target profile may be the next profile of the first target profile in the sequence.

In some embodiments, the second target profile may be the previous profile of the first target profile in the sequence. The positions of the next profile and the previous profile are relative. For a profile in the sequence, the next profile and the previous profile are located on both sides of the profile. For ease of description, in the present embodiment, the next profile of one profile can be understood as the profile corresponding to a more mature stage in the profession compared to that profile.

The above is only an example. The second target profile may be determined in other ways. For example, the second target profile may be randomly selected.

As another example, the one or more target profiles may include one profile. In this case, the profile may be the first target profile, or a profile determined based on the first target profile in the set of the profiles. For example, the profile may be selected according to the sequence of the profiles in the set of the profiles and the first target profile. The profile may be the next profile of the first target profile in the sequence.

The one or more target profiles may also include other numbers of profiles, and the embodiment of this disclosure is not limited to this. For example, the one or more target profiles may include n target profiles. n is an integer greater than 1. The n target profiles include the first target profile. The remaining n-1 target profiles may be n-1 profiles adjacent to the first target profile in the professional trajectory.

The model(s) corresponding to the one or more target profiles refers to the trained model(s) obtained using one or more subsets corresponding to the one or more target profiles.

For example, the model(s) corresponding to the first target profile refers to the trained model(s) obtained using one or more subsets corresponding to the first target profile. For another example, the model(s) corresponding to the second target profile refers to the trained model(s) obtained using one or more subsets corresponding to the second target profile.

Furtherly, In some embodiments, the one or more candidate models may be randomly selected from the model(s) corresponding to the one or more target profiles.

Furtherly, In some embodiments, the one or more candidate models may be selected from the model(s) corresponding to the one or more target profiles according to the context. In other words, the one or more candidate models may be determined according to the one or more target profiles and the context.

For example, the one or more candidate models may be determined according to the current context and the profile corresponding to the current user.

Context is a particular situation and environment where a problem is considered. Context may include external context and/or internal context.

The external context may be considered to be semantic specificity of an environment where a user is working. The environment may include at least one of the following: IDE, technology stack, or language.

Exemplarily, the external context may be determined according to IDE state, such as editing position, project, source file and code graph. As an example, the external context may include at least one of following: editing position, project, source file and code graph.

For example, the current external context may be determined according to the current IDE state, such as current editing position, current project, current source file and current code graph. The current external context may include the current IDE state. Or the current external context may include other information indicating current IDE state.

The internal context may be defined by the user personality, role, way of thinking, etc.

Exemplarily, the current internal context may be considered as reflecting the user's current state in IDE.

For example, the current internal context may be selected according to the class among a predefined set of classes reflecting the states of the developers. The current internal context may include the class reflecting the state of the current user. Or the internal context may include other information indicating the class reflecting the state of the current user.

The one or more target profiles and the context may be used in an appropriate form to determine the one or more candidate models. For example, the process of determining the one or more candidate models may be considered to be completed by a model selector. The output of the model selector may be the one or more candidate models. The inputs of the model selector may include at least one of the following: the profile embeddings of the one or more target profiles, the one or more target profiles themselves, content from the one or more target profiles, the context itself, the context embedding obtained by encoding the context or content from the context.

In operation 230, the one or more candidate models are applied to the context to generate one or more candidate outputs. In other words, the one or more candidate models are applied to the context to generate one or more candidate actions.

The details about operation 230 may refer to Example #1.

The following describes some examples about how to determine the target output.

### Example #1

In some embodiments, the method 200 may further include: determining a target action type according to the one or more target profiles and/or the context. The one or more candidate models are used for target action type. In other words, the one or more candidate models are used to generate action(s) of the target action type.

There may be a plurality of approaches to determine the target action type.

Exemplary, the target action type may be determined through the predefined heuristics.

The predefined heuristics may be formalized with rules related to the one or more target profiles and/or the context.

The rule related to the first target profile and the context is taken as an example. The context may include the class reflecting the state of the current user.

For example, the rule may be as follows: if the first target profile belongs to set #1 and the context belongs to set #2, the target type is action type #1. Set #1 may be a predefined set of profiles. Set #2 may be a predefined set of classes reflecting the states of the users.

The above is only an example, there may be other ways to determine the target type according to the one or more target profiles and/or the context.

In some embodiments, the one or more candidate models may be all model(s) used for the target type in the model(s) corresponding to the one or more target profiles.

Alternatively, the one or more candidate models may be partial model(s) used for the target type in the model(s) corresponding to the one or more target profiles.

The model selection may be performed according to a target query generated for the candidate action type. In Example #1, the candidate action type refers to the target action type.

A target query may be generated based on a pre-defined template associated with an action type. The target query generated for the action type may be called the target query corresponding to the action type.

A template may correspond to an action type. A target query corresponding to a candidate action type may be generated with the user query and/or the context based on the template corresponding to the candidate action type.

The prompt engineering and building prompt library are taken as an example. A template may be represented as a prompt specific to an action type (e.g. code review, code generation, question answering, etc.).

For example, the template may be a string with placeholders where the information from the context and/or the user query may be placed. The information from the context may be the imported library in the code. The user query may be a request to generate particular functionality of the code. The target query may be obtained by placing the information from the context and the target user query into the placeholders in the target template.

For another example, the template may be a function with a tuple of parameters as input and structured data as an output. The output of the target template may be the target query. The parameters may be obtained from at least one of the context, the user query or the information related to the user. The forms of the input and the output can be set as needed. The input and output may be strings, embeddings, semantic graphs, etc.

The following describes some example of prompts specific to some action types.

An example of prompt for code generation may be as follows:
{CURRENT CODE}
#{QUERY AS DOCSTRING}

Another example of prompt for code generation may be as follows:
{SELECTED LIBRARIES}
{VARIABLES}
#TASK: {QUERY}

The “QUERY” in the template may be replaced with the user query to obtain the target query. Such template may be used for code generation with existing code, which only imports library part with a user query such as “split data frame df1 into train and test subset”.

The prompt for code review may be with implicit query such as:

Provide a review for the following code:
. . .
{CURRENT CODE}
. . .

The prompt for question answering may be as follows:
QUESTION: {QUERY}
ANSWER:

The “QUERY” in the template may be replaced with the user query to obtain the target query. The user query may be the question obtained from the user. For example, the user query may be: “Explain how quicksort algorithm is working?”

One profile (such as the first target profile) is taken as an example to illustrate how to determine the one or more candidate models. There may be a plurality of models corresponding to the first target profile.

The target query may be fed into the models used for the target action type in the models corresponding to the first target profile. Or the target query may be fed into the models corresponding to the first target profile.

Models from the model DB may be preliminarily evaluated, filtered, and/or ranked.

As an example, the outputs of the models with the target query as input may be evaluated. The evaluation may be used for quality assessment. The one or more candidate models may be selected based on the evaluation.

Evaluation can be achieved in multiple ways.

The evaluation may be done with existing NLP metrics (such as CodeBLEU, Ruby and others for code) and/or with perceiving metric.

The perceiving metric may be used as an estimation of perceived usefulness of the output.

The perceiving metric may be achieved by a pretrained predictive model. The predictive model may also be called an evaluation model.

For example, the predictive model may be trained as a classification machine learning model or a regression machine learning model for perceived usefulness or regression-based perceived usefulness prediction.

Furtherly, the perceiving metric used for the quality assessment may be personalized perceiving metric. The personalized perceiving metric may also be referred to as the personalized assessment metric or personalized subjective metric. In other words, the perceiving metrics may vary for different users.

The personalized metric may be related to the information related to the target user. Or, the personalized metric may consider the user embedding. Or, the personalized metric may consider the first target profile. For example, the personalized metric may be the perceiving metric to be predicted by using the embedding of the first target profile as one of the arguments. In this way, the characteristics of the target user can be considered.

In this case, the predictive model may be replaced with a personalized evaluation model. The personalized evaluation model may be trained with the data selected for the particular profile.

Exemplarily, the models that have been fed into the target query may be ranked according to the evaluation. The higher the ranking of the model is, the higher its quality is. The one or more candidate models may be model(s) with higher ranking. For example, the one or more candidate models may be the top ranked model. For another example, the one or more candidate models may be models ranked in the top two.

The personalized perceiving metric is taken as an example. Namely, the one or more candidate models may be selected according to the personalized perceiving metric. The models that have been fed into the target query may be ranked according to the personalized perceiving metric corresponding to the first target profile. The higher the ranking of the model is, the higher its quality is. The one or more candidate models may be model(s) with higher ranking.

The above is only an example. The ranking is optional.

Two profiles (such as the first target profile and the second target profile) are taken as examples to illustrate how to determine the one or more candidate models. There may be a plurality of models corresponding to the first target profile and the second target profile.

The target query may be fed into the models used for the target action type in the models corresponding to the first target profile and the second target profile. Or the target query may be fed into the models corresponding to the first target profile and the second target profile.

The outputs of the models with the target query as input may be evaluated. The evaluation may be used for quality assessment. The one or more candidate models may be selected based on the evaluation.

The details about the evaluation may refer to the previous text, and will not be repeated here.

Exemplarily, the models that have been fed into the target query may be ranked according to the evaluation. The higher the ranking of the model is, the higher its quality is. The one or more candidate models may be model(s) with higher ranking.

The models corresponding to the first target profile and the models corresponding to the second target profile may be ranked together or separately. Correspondingly, there may be one ranking result or two ranking results. The one or more candidate models may be selected based on the one ranking result or two ranking results. For the case of two ranking results, the one or more candidate models may include the model(s) with higher ranking selected from each of the two ranking results.

The above is only an example. The ranking is optional.

The following describes an example of the one or more candidate models including two models.

As an example, the one or more candidate models may include a pair of models (an example of a first model and a second model) corresponding to the first target profile and the second target profile, respectively. The model selection may be performed twice with two sequential profiles (the first target profile and the second target profile). In each selection there will be a single selected model.

For example, the first target profile is profile #1 in the set of the profiles, while the second target profile is profile #2 in the set of the profiles. There are three available action types: code review, code generation, and question answering. The target action type may be determined as code generation. The target template corresponding to the code generation may be filled with a target user query <q>. The target template for code generation may be as follows: “{CURRENT CODE} \n #{QUERY} \n”. For a target user query <q>a particular prompt (e.g., the target query to be fed into the model) is built. The profile #1 corresponds to three models (model #1, model #2 and model #3) in the model database. The profile #2 corresponds to two models (model #4 and model #5) in the model database. Thus, five models may be determined based on the profile #1 and the profile #2. A pair of models needs to be selected from the five models. The target query is fed into the five models to obtain the outputs of the five models. Correspondingly, there are five outputs: output #1, output #2, . . . output #5, respectively from model #1, model #2, . . . model #5. The evaluation results are as follows: among the 3 outputs provided by the model #1, model #2 and model #3, output #1 has the highest quality, while among the 2 outputs provided by the model #4 and model #5, output #5 has the highest quality. Output #1 is provided by the model #1. Output #5 is provided by the model #5. Therefore, model #1 and model #5 are selected.

The above is only an example, and the other implementation details about each selection may refer to the previous text, and will not be repeated here.

In operation 230, the target output may be determined based on the output(s) of the one or more candidate models that takes the target query as input.

In the case of only one candidate model, the output of the candidate model may be used as the target output.

The following describes how to determine the target output in the case of multiple candidate models.

Exemplarily, the target output may be selected from the outputs of the candidate models.

For example, the target output may be randomly selected from the outputs of the candidate models.

For another example, the target output may be selected from the outputs of the candidate models based on their corresponding probabilities.

As an example, the probabilities corresponding to the candidate models may be related to the evaluation results of the outputs of the candidate models. For example, the probabilities corresponding to the candidate models may be positively correlated with the quality of the outputs of the candidate models.

In this case, the outputs of the candidate models are re-evaluated. For example, the outputs of the candidate models may be re-evaluated according to the identified context with the target action type. Furthermore, other processing may be performed on the candidate outputs to determine the target output, such as ranking or filtering.

As another example, the candidate models may include models corresponding to different profiles. The probabilities corresponding to the candidate models may be related to the distances between the profiles corresponding to the candidate models and the user's profile. For example, the probabilities corresponding to the candidate models may be negatively correlated with distances between the profiles corresponding to the candidate models and the user's profile.

Exemplarily, the target output may be obtained by mixing the outputs of the candidate models.

Mixing the outputs of the candidate models may include mixing all or part of the outputs of the candidate models.

Code generation is taken as an example. The output of the model may be the probabilities of top tokens. While generating each new token in a generative language model, probabilities of top tokens may be weighted averaged.

For example, the target output may be obtained based on the average of the outputs of the candidate models.

For another example, the target output may be obtained based on the weighted average/sum of the outputs of the candidate models.

The weights may be determined as needed.

As an example, the weights may be randomly determined.

As another example, the candidate models may include models corresponding to different profiles. The weights for the candidate models may be determined according to the distances between the profiles corresponding to the candidate models and the user's profile.

As an example embodiment, a weighted ensemble of the candidate models may be obtained to determine the target output. The weighted ensemble model may be obtained by integrating the candidate models according to the weights for the candidate models. The candidate models may include models corresponding to different profiles. The weights for the candidate models may be determined according to the distances between the profiles corresponding to the candidate models and the user's profile. As an example, the weights for the candidate models in the model ensemble may be positively correlated with the distances between the profiles corresponding to the candidate models and the user's profile.

A pair of models corresponding to the first target profile and the second target profile is taken as an example. The first model and the second model are integrated to obtain a weighted ensemble model, which may be used to generate a candidate action.

For example, the weights for two models may be determined proportionally based on the distance between the profile embedding of the first target profile and the user embedding, as well as the distance between the profile embedding of the second target profile and the user embedding. The weights for two models may meet the following formula:

$${ω}_{i} = ‖ {U}_{1} - {P}_{i} ‖ / {\sum }_{j ∈ \{ 1 , 2 \}} ‖ {U}_{1} - {P}_{j} ‖ ;$$

ωᵢ is a weight for a model corresponding to the i-th target profile. i=1, 2. Pᵢ is a profile embedding of the i-th target profile. Pⱼ is a profile embedding of the j-th target profile. U₁ is a user embedding.

As an example, the target output may meet the following formula:

$${O}_{target} = {ω}_{1} {O}_{1} + {ω}_{2} {O}_{2} ;$$

O_{target} is the target output. O₁ is the output of the candidate model (an example of the first model) corresponding to the first target profile. O₂ is the output of the candidate model (an example of the second model) corresponding to the second target profile.

For a weighted ensemble model, the input may be the target query and the output may be the mixed output of the candidate models.

If there are multiple candidate models, the candidate models may be integrated to one or more weighted ensemble model models, which are used to generate the one or more candidate actions. For example, the candidate models may include multiple pairs of models (an example of multiple first models and multiple second models). Each pair of models includes a candidate model (an example of the first model) corresponding to the first target profile and a candidate model (an example of the second model) corresponding to the second target profile. For each weighted ensemble model, there are two candidate models corresponding to the first target profile and the second target profile, respectively. In other words, for each weighted ensemble model, the weighted ensemble model may be running using a candidate model corresponding to the first target profile and a candidate model corresponding to the second target profile. Furtherly, the weights for the one or more first models and the one or more second models may be positively correlated with distance between the first target profile and the information related to the target user and the distance between the second target profile and the information related to the target user. For example, for each pair of models, the weights for the models may refer to the formula mentioned earlier.

If there are multiple candidate models, the target output may be determined from the outputs of the weighted ensemble models. For example, the outputs of the weighted ensemble models may be re-evaluated according to context through selection of the target action type. The target output may be selected from the outputs of the weighted ensemble models according to re-evaluation results.

The following is an example process for determining the target output.
(1) Determining the target action type.

The target action type may be solved according to predefined heuristics.
(2) Selecting candidate models to run.

Multiple candidate models are used as examples, and in other implementations, one candidate model can be selected. Please refer to the previous text for specific descriptions.
(3) Running weighted ensemble models.

Multiple weighted ensemble models are used as examples, and in other implementations, one weighted ensemble model can be used here. Please refer to the previous text for specific descriptions.

For example, for each weighted ensemble model, the weighted ensemble model may be running using a candidate model corresponding to the current profile (an example of the first target profile) and a candidate model corresponding to a next profile (an example of the second target profile) in a professional trajectory.
(4) Revaluating the outputs of the weighted ensemble models according to the context with selection of NBA.

For example, the outputs of the weighted ensemble models may be evaluated according to the perceiving metrics related to the context.
(5) Selecting the best output (e.g., the target output) according to re-evaluation results.

In addition, in case of multiple PLMs, multi-agent selection of the target output may be considered. For example, if multiple developers are involved in software development at the same time, the technical solution proposed in this disclosure may be used to provide programming supports for the multiple developers, respectively, that is, to select target output for each developer. In this case, a multi-agent solution can be considered.

### Example #2

In some embodiments, the one or more candidate models may be used for the same action type or different action types.

In some embodiments, the one or more candidate models may be all model(s) in the model(s) corresponding to the one or more target profiles.

Alternatively, the one or more candidate models may be partial model(s) in the model(s) corresponding to the one or more target profiles.

The one or more candidate models may be selected according to the target queries generated for candidate action types. In Example #2, the candidate action types may be all available action types that the models in the model DB may be used for.

The details about the target query may refer to the previous text, and will not be repeated here.

One profile (such as the first target profile) is taken as an example to illustrate how to determine the one or more candidate models. There may be a plurality of models corresponding to the first target profile. The models corresponding to the first target profile may be used for the same action type or different action types. The following describes an example of the models corresponding to the first target profile that are used for different action types.

The target queries may be fed into the models used for the corresponding action types in the models corresponding to the first target profile, respectively. For example, if target query #A is generated for action type #A, the target query #A may be fed into the model(s) used for action type #A in the models corresponding to the first target profile. Alternatively, the target queries may be fed into all the models corresponding to the first target profile.

The outputs of the models may be evaluated. The evaluation may be used for quality assessment. The one or more candidate models may be selected based on the evaluation.

The details about the evaluation may refer to the previous text, and will not be repeated here.

Exemplarily, the models corresponding to the first target profile may be ranked according to the evaluation. The higher the ranking of the model is, the higher its quality is. The one or more candidate models may be model(s) with higher ranking.

The above is only an example. The ranking is optional.

Two profiles (such as the first target profile and the second target profile) are taken as examples to illustrate how to determine the one or more candidate models. There may be a plurality of models corresponding to the first target profile and the second target profile.

The target queries may be fed into the models used for the corresponding action types in the models corresponding to the first target profile and the second target profile, respectively. Alternatively, the target queries may be fed into the all the models corresponding to the first target profile and the second target profile.

The outputs of the models may be evaluated. The evaluation may be used for quality assessment. The one or more candidate models may be selected based on the evaluation.

The details about the evaluation may refer to the previous text, and will not be repeated here.

Exemplarily, the models corresponding to the first target profile and the second target profile may be ranked according to the evaluation. The higher the ranking of the model is, the higher its quality is. The one or more candidate models may be model(s) with higher ranking.

The models corresponding to the first target profile and the models corresponding to the second target profile may be ranked together or separately. Correspondingly, there may be one ranking result or two ranking results. The one or more candidate models may be selected based on the one ranking result or two ranking results. For the case of two ranking results, the one or more candidate models may include the model(s) with higher ranking selected from each of the two ranking results.

The above is only an example. The ranking is optional.

As an example, the one or more candidate models may include a pair of models (an example of a first model and a second model) corresponding to the first target profile and the second target profile, respectively. A pair of models may be selected according to target queries generated for each available action type. The model selection may be performed twice with two sequential profiles (the first target profile and the second target profile). In each selection there will be a single selected model.

In operation 230, the target output may be determined based on the output(s) of the one or more candidate models that take the target queries as input. In other words, the one or more candidate models may be used to generate outputs for all available queries (such as the target queries). Then the target output may be determined based on the outputs.

In one embodiment, at the same time as determining the target output, the target action type is also determined.

Alternatively, the target action type may be selected from the multiple candidate action types before the determination of the target output.

As mentioned before, a weighted ensemble of the candidate models may be obtained to determine the target output. In this case, each target query may be associated with a weighted ensemble of the candidate models.

The details about operation 230 may refer to the Example #1, and will not be repeated here.

According to the technical solution of the embodiment in this disclosure, the profiles may be organized in sequence representing the professional trajectory, which is conducive to providing professional growth support for users at different professional levels and further improving the user experience.

In addition, the candidate model corresponding to the second target profile may be involved in the generation process of the target output, where the second target profile may be the next profile of the first target profile that may match the current user based on the professional trajectory. The first target profile may be understood as the profile that best matches the current user's professional level, while the second target profile may be understood as the profile of the current user's higher level of professional. When the candidate model corresponding to the second target profile is involved in determining the target output, that is, the user is pushed towards higher-level profile along the professional trajectory, which may stimulate the professional growth of the user.

What's more, candidate models corresponding to the target profiles may be integrated to obtain the ensemble model which is used to determine the target output. This is conducive to providing corresponding support for users at different professional levels while promoting the professional growth, thereby further improving the user experience.

FIG. 3 shows a schematic flowchart of another method for programming. The method of FIG. 3 may be considered as an example of the method 200. The relevant details refer to the method 200. To avoid repetition, some descriptions may be omitted when method of FIG. 3 is described.

The method of FIG. 3 may be applied to a pair programming scenario.

As shown in FIG. 3, the method of FIG. 3 may be considered to include three phases (e.g., phase 1, phase 2 and phase 3).

Phase 1 includes identification of the target profile. Phase 1 may be implemented through the following operations.
(1) Obtain information related to a current user.

For example, as shown in FIG. 3, obtain the user's profile. The user's profile is from the characteristics of the current user.
(2) Correct a profile.

Correcting the profile refer to aligning the information related to the current user to the existing profiles.

A set of predefined profiles is used to match the most relevant one(s) for the current user's profile.

For example, the user embedding is aligned to the embeddings of the profiles in the set of the profiles to obtain the embedding of the target profile (e.g., the profile embedding in FIG. 3).

Phase 2 includes selection of the candidate models. Phase 2 may be implemented through the following operations.
(3) Extract the context.

For example, the context in FIG. 3 may be the external context. The extracted context may be represented as a context embedding.
(4) Select candidate models from a model DB.

For example, as shown in FIG. 3, the candidate models are selected according to the context embedding and the profile embedding.

Phase 3 includes determination of the target output (e.g., the next action in FIG. 3). Phase 3 may be implemented through the following operations.
(5) Apply the candidate models to generate candidate outputs (e.g., the candidate actions in FIG. 3).

The candidate models are applied to the context to generate possible actions to be applied.
(6) Select the target output.

The target output is determined based on the candidate outputs.

For example, as shown in FIG. 3, the candidate actions generated in operation (5) may be evaluated and ranked to determine the next action.

In this way, the target output which can be considered as the NBA in the current context for the current user's profile may be determined.

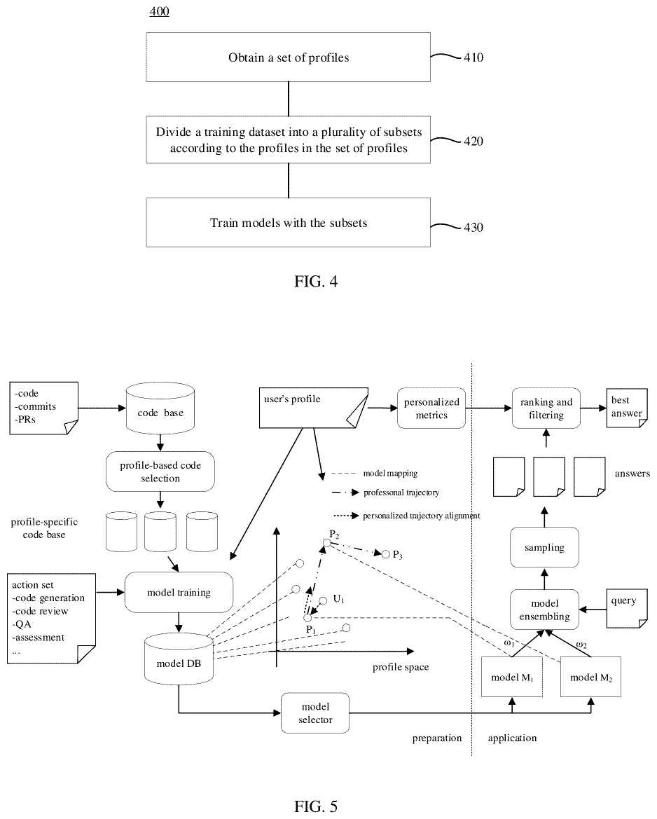

FIG. 4 shows a schematic flowchart of a method for obtaining the model database in the method 200. The relevant details refer to the method 200. To avoid repetition, some descriptions may be omitted when the method 400 is described.

As shown in FIG. 4, the method 400 may include the following operations.

410, Obtain a set of profiles.

The details about the set of profiles may refer to the method 200.

420, Divide a training dataset into a plurality of subsets according to profiles in the set of profiles.

The training dataset includes a plurality of training samples. The training sample may also be called training data. The training samples may be collected from data related to the users during the programming process. In other words, the training samples may be collected from the software development data of users. As an example, the training samples may be collected from the code base and/or text base of the users. For example, as shown in FIG. 5, the code base may include code, commits and PRs.

Each training sample may be associated with a user or a user's profile. Correspondingly, each training sample may be associated with a profile in the set of profiles. The training samples may be split into a plurality of subsets according to the profiles in the set of profiles.

For example, there are four training samples: training sample #a, training sample #b, training sample #c, and training sample #d. There are two profiles in the set of profiles: profile #a and profile #b. These four training samples may be collected from data related to four users (user #a, user #b, user #c and user #d), respectively. The profile may include position, such as junior, middle, senior, or leader. The position in profile #a may be junior. The position in profile #b may be senior. The position of the four users may be junior, senior, senior and junior. Thus, the user #a and user #d may correspond to the profile #a. The user #b and user #c may correspond to the profile #b. In this way, the four training samples may be split into two subsets corresponding to the two profiles. One subset corresponding to the profile #a includes the training sample #a and the training sample #d, while the other subset corresponding to the profile #b includes the training sample #b and the training sample #c.

In some embodiments, the number of the subsets may be the same as the number of the profiles. Each profile corresponds to a subset.

Alternatively, the number of the subsets may be different from the number of the profiles. One profile may correspond to at least one subset.

430, Train models with the subsets.

The original models to be trained with the subsets may include untrained models or pre-trained models. For example, a single original model (such as UnixCoder, CodeLlama, etc.) may be configured or finetuned for different programming tasks with configuration, or finetuning on the subsets.

The model database is used to store a plurality of trained models or pretrained models. For the convenience of description, in the embodiments of this disclosure, the model database storing the trained models is taken as an example.

Models may be trained for predefined a set of actions using the subsets. Each action type may correspond to one programming task. The type(s) of the action(s) in the set of actions may include at least one of code completion, code review, QA, etc. In other words, the models are trained for one or more programming tasks using the subsets.

In general, assuming there are N_A action types, N_M original models and N_P subsets. Thus, there may be N_A×N_M×N_P settings for model training. In practice, not all models may be applied to provide all actions. Thus, the number of the trained models may be less than N_A×N_M×N_P. N_A, N_M and N_P are positive integer greater than 1.

Trained models are stored in the model DB.

For example, the weights of the trained models and the running procedures of the trained models may be stored in the model DB.

There may be a link between the model DB and the profile space. For example, the trained model may be associated with the embedding of the profile corresponding to the subset used to obtain the trained model.

The operation 430 may be referred to as profile-based model training.

FIG. 5 shows a schematic diagram of the overall processing flow in a pair programming scenario. The relevant details refer to the method 200 and the method 400. To avoid repetition, some descriptions may be omitted when FIG. 5 is described.

As shown in FIG. 5, the overall processing flow may include two stages: preparation and application.

In the preparation stage, the candidate model(s) may be obtained. For example, as shown in FIG. 5, a pair of candidate models are selected.

In the application stage, the candidate model(s) may be applied to obtain target output. For example, as shown in FIG. 5, the best answer (e.g., an example of the target output) may be determined.

The following describes the preparation stage.

### (a) Profile-Based Training Data Selection.

The profile-based training data selection refer to splitting the training data into subsets according to the profiles in the set of the profiles.

For example, as shown in FIG. 5, the training dataset may include code base of a plurality of users. The code base may include code, commits and PRs. The code bases of the plurality of users may be split into subsets according to the set of profiles. The subsets may also be referred to as profile-specific code bases.

The code base in FIG. 5 is merely an example. The training dataset may also include other data base, such as text base. The code base may also include other type of data, such as a set of used libraries or programming language.

The descriptions of the training dataset and the subsets may refer to the method 400, and will not be repeated here.

### (b) Model Training.

A set of original models, such as LLMs, may be trained for a predefined set of actions.

For example, as shown in FIG. 5, the action set may include code generation, code review, assessment, QA, etc.

The trained models are stored in the model DB keeping a link to profile space. For example, as shown in FIG. 5, the models in the model DB may be mapped to the embeddings of the profiles in the set of the profiles in the profile space. The profiles in the set of the profiles may be organized in sequence, e.g. P₁→P₂→P₃ in FIG. 5. The sequence reflects a professional trajectory. P₁, P₂ and P₃ correspond to three profiles in the set of the profiles.

### (c) Profile Identification.

The user embedding may be obtained through the mapping procedure which is the same as the mapping procedure used to obtain the embeddings of the profiles in the set of profiles. Then the nearest profiles in the set of the profiles may be determined. For example, as shown in FIG. 5, the embedding of P₁ (an example of the first target profile) is closest to the user embedding U₁.

Further, P₁, as well as the next profile of P₁ in the professional trajectory, i.e. P₂ (an example of the second target profile) in FIG. 5, is used as a reference for model selection. For U₁ or the user, the process of determining P₂ based on Pᵢ may be referred to as personalized trajectory alignment.

### (d) Model Selection.

A pair of models for sequential profiles (P₁ and P₂) may be selected according to a set of queries generated for each available action type. Each query is associated with a weighted ensemble of the two models.

The weights for the two models in model ensemble are positively correlated with the distances between the embedding of the profiles corresponding to the two models and the user embedding.

For example, there are two models corresponding to P₁ and P₂ respectively: M₁ and M₂. The weight for M₁ and the weight for M₂ may be determined proportionally based on the distance between the embedding of P₁ and U₁, as well as the distance between the embedding of P₂ and U₁. The details may refer to the Example #1.

The following describes the application stage.

### (e) Model Ensembling.

Integrate M₁ and M₂ according to the weights for the two models to obtain a weighted ensemble model. The weighted ensemble model is used to generate samples available as possible actions for all available queries.

### (f) Output Sampling.

Sample the generated possible outputs to obtain the candidate outputs, such as the answers in FIG. 5.

This operation is optional. If there is no such operation, the generated possible outputs may also be used as candidate outputs.

### (g) Ranking and Filtering.

For example, the generated outputs may be evaluated according to personalized metrics to determine the target output. Further, the generated outputs may be filtered and ranked according to the evaluation results. As shown in FIG. 5, the personalized metrics may be determined based on the user's profile.

The result of filtering and ranking may be used to select NBA (such as the best answer) in current context and for current user.

This operation is optional.

The technical solution in the embodiment of this disclosure may be applied to a plurality of scenarios.

Exemplarily, the technical solution in the embodiment of this disclosure may be applied to IDE to provide personalized support for the users.

For example, the users may include employers in a company, in which case, the professional trajectory may be used to reflect the professional growth of developers in general position (such as, junior→middle→senior) or internal grade based on the combination with area of expertise.

The models may work as AI agents in the pair programming. The technical solution in the embodiment of this disclosure may provide proper support to the users instead of copying the behavior of the users.

For another example, the users may include students who are working with IDE. In other words, the technical solution in the embodiment of this disclosure may be applied to an education scenario. The professional trajectory may be used to reflect education paths arranged according to a study plan.

Exemplarily, the technical solution in the embodiment of this disclosure may be applied to question-answering (QA) services or chat-bots. In this case, the models in the model DB may be used to solve QA tasks. A user may use this service to query programming questions. By identifying the profile corresponding to the user, a matching model may be selected to make the answer more personalized.

The technical solution in the embodiment of this disclosure may be further applied to train a series of collaborative AI agents acting together to solve the software development problems in a predefined way (such as “hard coding” in MetaGPT or ChatDev) or a flexible self-regulation way implemented for value-based personalized assessment and self-assessment of agents, such as through multi agent reinforcement learning (MARL). In this way, a new IDE may be provided, as shown in (d) of FIG. 1, where AI agents are the main “developers”, rather than humans being as the main “developers”.

The method according to the embodiments of this disclosure is described in detail above, and the apparatus according to the embodiments of this disclosure will be described below with reference to FIGS. 7-10. The apparatus described below is capable of performing the methods described in the embodiments of this disclosure. For brevity, the repeated description is appropriately omitted at the time of introducing the apparatus in the embodiments of this disclosure.

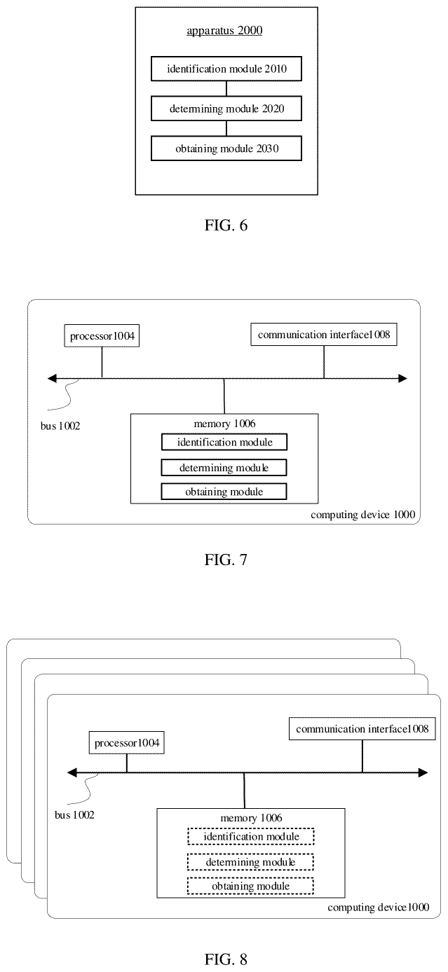

FIG. 6 is a schematic block diagram of an apparatus 2000 according to an embodiment of this disclosure. The apparatus 2000 shown in FIG. 6 may be used to perform the method shown in FIG. 2, FIG. 3, FIG. 4 or FIG. 5.

As shown in FIG. 6, the apparatus 2000 includes an identification module 2010, a determining module 2020 and an obtaining module 2030.

The identification module 2010 is configured to identify a first target profile from a set of profiles according to information related to a target user. The set of profiles is obtained according to information related to users, and each profile in the set of profiles corresponds to a category of the information related to the users.

The determining module 2020 is configured to determine one or more candidate models from a model database according to the first target profile. The models in the model database are trained models obtained through subsets of a training dataset. The models are used for programming tasks. The subsets are obtained by dividing the training dataset based on the set of profiles.

The obtaining module 2030 is configured to obtain a target action from one or more candidate actions generated by applying the one or more candidate models to context.

In some embodiments, profiles in the set of profiles are organized in sequence which is used to represent professional growth of a user.

In some embodiments, the one or more candidate models include one or more first models and one or more second models. The one or more first models are trained models obtained using one or more subsets in the subsets of the training dataset corresponding to the first target profile. The one or more second models are trained models obtained using one or more subsets in the subsets of the training dataset corresponding to a second target profile. The second target profile is next profile of the first target profile in the sequence.

In some embodiments, the one or more first models and the one or more second models are integrated to obtain one or more weighted ensemble models, which are used to generate the one or more candidate actions.

In some embodiments, weights for the one or more first models and the one or more second models are positively correlated with distances between the first and second target profiles and the information related to the target user.

In some embodiments, in the set of profiles, a distance between the first target profile and the information related to the target user is the smallest.

In some embodiments, the information related to the users includes at least one of following: users' personal information, users' text bases, users' code bases, users' repository activities, results of a questionnaire for identifying users' profiles, or users' states in integrated development environment.

In some embodiments, the context is obtained according to at least one of following: editing position, project, source file, or code graph.

The specific description can refer to the methods mentioned earlier, and will not be repeated here.

The term “module” herein may be implemented in software and/or hardware without specific limitation. For example, a “module” may be a software program, a hardware circuit, or a combination of the above functions. The obtaining module 2030 is taken as an example. The implementation of the obtaining module 2030 will be introduced. Similarly, the implementation of other modules can refer to the implementation of the obtaining module 2030.

As an example of a software functional unit, the obtaining module 2030 may include code running on a computing instance. The computing instance may include at least one of a physical host (computing device), a virtual machine, or a container. Furthermore, the above computing instance can be one or more in number. For example, the obtaining module 2030 may include code running on multiple hosts/virtual machines/containers. Multiple hosts/virtual machines/containers used to run the code may be distributed in the same region or in different regions. Furthermore, multiple hosts/virtual machines/containers used to run the code may be distributed within the same availability zone (AZ) or across different AZs, each of which includes a data center or multiple geographically close data centers. Typically, a region may include multiple AZs.

Similarly, multiple hosts/virtual machines/containers used to run the code may be distributed within the same virtual private cloud (VPC) or across multiple VPCs. One VPC may be set within a region, and communication between two VPCs within the same region, as well as cross regional communication between VPCs from different regions, requires a communication gateway to be set up within each VPC to achieve interconnection between VPCs.

As an example of a hardware functional unit, the obtaining module 2030 may include at least one computing device, such as a server, etc. Alternatively, the obtaining module 2030 may also be a device implemented using application specific integrated circuits (ASICs) or programmable logic devices (PLDs). The above mentioned PLD can be a complex programmable logic device (CPLD), field programmable gate array (FPGA), general array logic (GAL), or any combination thereof.

The obtaining module 2030 includes multiple computing devices that can be distributed in the same region or in different regions. The obtaining module 2030 includes multiple computing devices that can be distributed within the same AZ or across different AZs. Similarly, the obtaining module 2030 includes multiple computing devices that can be distributed within the same VPC or across multiple VPCs. The multiple computing devices can be any combination of computing devices such as servers, ASICs, PLDs, CPLDs, FPGAs, and GALs.

In other embodiments, the obtaining module 2030 can be used to execute any operation in the method for programming, the identification module 2010 can be used to execute any operation in the method for programming, and the determining module 2020 can be used to execute any operation in the method for programming. The operations responsible for implementing each module can be specified as needed, and different operations in the method for programming can be implemented by each module to achieve all functions of the apparatus 2000.

The present application also provides a computing device 1000. As shown in FIG. 7, the computing device 1000 includes: bus 1002, processor 1004, memory 1006, and communication interface 1008. The processor 1004, memory 1006, and communication interface 1008 communicate through the bus 1002. The computing device 1000 can be a server or terminal device. It should be understood that this disclosure does not limit the number of processors and memory in the computing device 1000.

Bus 1002 can be a peripheral component interconnect (PCI) bus or an extended industry standard architecture (EISA) bus, etc. Buses can be divided into address buses, data buses, control buses, etc. For ease of representation, only one line is used in FIG. 7, but it does not mean that there is only one bus or one type of bus. Bus 1002 may include pathways for transmitting information between various components of computing device 1000 (such as memory 1006, processor 1004, communication interface 1008).

Processor 1004 may include any one or more of a central processing unit (CPU), graphics processing unit (GPU), microprocessor (MP), or digital signal processor (DSP).

Memory 1006 may include volatile memory, such as random access memory (RAM). Processor 1004 may also include non-volatile memory, such as read-only memory (ROM), flash memory, hard disk drive (HDD), or solid state drive (SSD).

Memory 1006 stores executable program code, and processor 1004 executes the executable program code to respectively implement the functions of the identification module 2010, the determining module 2020 and the obtaining module 2030, thereby realizing the method for programming. That is to say, instructions for executing the method for programming are stored on memory 1006.

Communication interface 1008 uses transceiver modules such as but not limited to network interface cards and transceivers to achieve communication between computing device 1000 and other devices or communication networks.

The embodiment of this disclosure also provides a computing device cluster. The computing device cluster includes at least one computing device. The computing device can be a server, such as a central server, an edge server, or a local server in a local data center. In some embodiments, the computing device may also be a terminal device such as a desktop computer, laptop, or smartphone.

As shown in FIG. 8, the computing device cluster includes at least one computing device 1000. Memory 1006 in one or more computing devices 1000 in a computing device cluster may store the same instructions for executing the method for programming.

In some embodiments, memory 1006 of one or more computing devices 1000 in the computing device cluster may also store partial instructions for executing the method for programming. In other words, a combination of one or more computing devices 1000 can jointly execute instructions for executing the method for programming.

Memory 1006 in different computing devices 1000 in the computing device cluster can store different instructions, which are respectively used to execute some functions of the apparatus for programming. That is to say, the instructions stored in memory 1006 of different computing devices 1000 may realize the functions of one or more modules in the identification module 2010, the determining module 2020 and the obtaining module 2030.

In some embodiments, one or more computing devices in a computing device cluster may be connected through a network. The network can be a wide area network, a local area network, or the like.

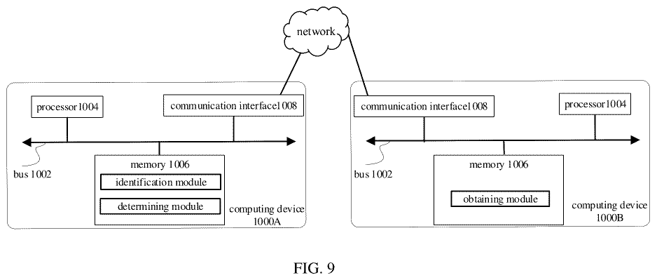

FIG. 9 illustrates an example embodiment. As shown in FIG. 9, two computing devices 1000A and 1000B are connected through a network. For example, computing devices 1000A and 1000B are connected to the network through communication interfaces in various computing devices. In the embodiment, memory 1006 in the computing device 1000A stores instructions to execute the function of the identification module 2010 and the determining module 2020. Meanwhile, memory 1006 in computing device 1000B stores instructions to execute the functions of the obtaining module 2030.

The connection method between the computing device clusters shown in FIG. 9 may take into account that the method for programming provided in this disclosure may require data storage, and therefore consider entrusting the functions implemented by the obtaining module 2030 to the computing device 1000B for execution.

The functions of the computing device 1000A shown in FIG. 9 can also be accomplished by multiple computing devices 1000. Similarly, the functions of computing device 1000B can also be accomplished by multiple computing devices 1000.

An embodiment of this disclosure further provides a computer program product. When the instructions are executed by a computing device cluster, the computing device cluster performs any of the foregoing methods.

An embodiment of this disclosure further provides a computer-readable storage medium, storing one or more instructions. When the one or more instructions are executed by a computing device cluster, the computing device cluster performs any of the foregoing methods.

A person of ordinary skill in the art will be aware that, in combination with the examples described in the embodiments disclosed in this specification, units and algorithm operations may be implemented by using electronic hardware or a combination of computer software and electronic hardware. Whether the functions are performed by using hardware or software depends on particular applications and design constraint conditions of the technical solutions. A person skilled in the art may use different methods to implement the described functions for each particular application, but it should not be considered that the embodiment goes beyond the scope of this disclosure.

It would be understood by a person skilled in the art that, for the purpose of convenience and brevity, in a detailed working process of the foregoing system, apparatus, and unit, reference may be made to a corresponding process in the foregoing method embodiments, and details are not described herein again.

In the several embodiments provided in this disclosure, the disclosed system, apparatus, and method may be implemented in other manners. For example, the described apparatus embodiment is merely an example. For example, the unit division is a logical function division and other methods of division may be used in an actual embodiment. For example, a plurality of units or components may be combined or integrated into another system, or some features may be ignored or not performed. In addition, the displayed or discussed mutual couplings or direct couplings or communication connections may be implemented using various communication interfaces. The indirect couplings or communication connections between the apparatuses or units may be implemented in electronic, mechanical, or other forms.

The units described as separate parts may or may not be physically separate, and parts displayed as units may or may not be physical units, that is, the parts may be located in one unit, or may be distributed among a plurality of network units. Some or all of the units may be selected based on actual requirements to achieve the objectives of the embodiments.

In addition, function units in the embodiments of this disclosure may be integrated into one processing unit, each of the units may exist alone physically, or two or more units may be integrated into one unit.

When the functions are implemented in the form of a software functional unit and sold or used as an independent product, the functions may be stored in a computer-readable storage medium. The technical solutions of this disclosure may be implemented in the form of a software product. The software product is stored in a storage medium, and includes several instructions for instructing a computer device (which may be a personal computer, a server, a network device, or the like) to perform all or some of the operations of the methods described in the embodiments of this disclosure. The foregoing storage medium includes any medium that can store program code, such as a USB flash drive, a removable hard disk, a read-only memory (ROM), a random access memory (RAM), a magnetic disk, an optical disc or the like.

The foregoing descriptions are merely specific embodiments of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. A method for programming, comprising:
obtaining a set of profiles according to information related to users;
identifying a first target profile from the set of profiles according to information related to a target user of the users, wherein a profile in the set of profiles corresponds to a category of the information related to the users;
obtaining models in a model database trained through subsets of a training dataset, the models being used for programming tasks, and the subsets of the training dataset are obtained by dividing the training dataset based on the set of profiles;
determining one or more candidate models from the model database according to the first target profile;
applying the one or more candidate models to context to generate one or more candidate actions; and
obtaining a target action from the one or more candidate actions.

2. The method according to claim 1, wherein profiles in the set of profiles are organized in sequence which is used to represent professional growth of a user.

3. The method according to claim 2, wherein the one or more candidate models comprise one or more first models and one or more second models, the one or more first models are trained models obtained using one or more subsets in the subsets of the training dataset corresponding to the first target profile, the one or more second models are trained models obtained using one or more subsets in the subsets of the training dataset corresponding to a second target profile, and the second target profile is a next profile of the first target profile in the sequence.

4. The method according to claim 3, wherein the one or more first models and the one or more second models are integrated to obtain one or more weighted ensemble models, and the one or more weighted ensemble models are used to generate the one or more candidate actions.

5. The method according to claim 4, wherein weights for the one or more first models and the one or more second models are positively correlated with distances between the first and second target profiles and the information related to the target user.

6. The method according to claim 1, wherein in the set of profiles, a distance between the first target profile and the information related to the target user is the smallest.

7. The method according to claim 1, wherein the information related to the users comprises at least one of following: users' personal information, users' text bases, users' code bases, users' repository activities, results of a questionnaire designed to identify users' profiles, or users' states in integrated development environment.

8. The method according to claim 1, wherein the context is obtained according to at least one of following: editing position, project, source file, or code graph.

9. An apparatus for programming, comprising:
a memory; and
a processor coupled with the memory, the processor and the memory are configured to:
identify a first target profile from a set of profiles according to information related to a target user, wherein the set of profiles is obtained according to information related to users, and each profile in the set of profiles corresponds to a category of the information related to the users;
determine one or more candidate models from a model database according to the first target profile, wherein models in the model database are trained models obtained through subsets of a training dataset, the models are used for programming tasks, and the subsets are obtained by dividing the training dataset based on the set of profiles; and
obtain a target action from one or more candidate actions generated by applying the one or more candidate models to context.

10. The apparatus according to claim 9, wherein profiles in the set of profiles are organized in sequence which is used to represent professional growth of a user.

11. The apparatus according to claim 10, wherein the one or more candidate models comprise one or more first models and one or more second models, the one or more first models are trained models obtained using one or more subsets in the subsets of the training dataset corresponding to the first target profile, the one or more second models are trained models obtained using one or more subsets in the subsets of the training dataset corresponding to a second target profile, and the second target profile is a next profile of the first target profile in the sequence.

12. The apparatus according to claim 11, wherein the one or more first models and the one or more second models are integrated to obtain one or more weighted ensemble models, and the one or more weighted ensemble models are used to generate the one or more candidate actions.

13. The apparatus according to claim 12, wherein weights for the one or more first models and the one or more second models are positively correlated with distances between the first and second target profiles and the information related to the target user.

14. The apparatus according to claim 9, wherein in the set of profiles, a distance between the first target profile and the information related to the target user is the smallest.

15. The apparatus according to claim 9, wherein the information related to the users comprises at least one of following: users' personal information, users' text bases, users' code bases, users' repository activities, results of a questionnaire designed to identify users' profiles, or users' states in integrated development environment.

16. The apparatus according to claim 9, wherein the context is obtained according to at least one of following: editing position, project, source file, or code graph.

17. A computing device cluster, comprising:
at least one computing device including a processor and a memory, the processor of the at least one computing device is configured to perform instructions stored in the memory of the at least one computing device, and the computing device cluster is configured to:
identify a first target profile from a set of profiles according to information related to a target user, wherein the set of profiles is obtained according to information related to users, and each profile in the set of profiles corresponds to a category of the information related to the users;
determine one or more candidate models from a model database according to the first target profile, wherein models in the model database are trained models obtained through subsets of a training dataset, the models are used for programming tasks, and the subsets are obtained by dividing the training dataset based on the set of profiles; and
obtain a target action from one or more candidate actions generated by applying the one or more candidate models to context.

18. The computing device cluster according to claim 17, wherein profiles in the set of profiles are organized in sequence which is used to represent professional growth of a user.

19. The computing device cluster according to claim 18, wherein the one or more candidate models comprise one or more first models and one or more second models, the one or more first models are trained models obtained using one or more subsets in the subsets of the training dataset corresponding to the first target profile, the one or more second models are trained models obtained using one or more subsets in the subsets of the training dataset corresponding to a second target profile, and the second target profile is a next profile of the first target profile in the sequence.

20. The computing device cluster according to claim 19, wherein the one or more first models and the one or more second models are integrated to obtain one or more weighted ensemble models, and the one or more weighted ensemble models are used to generate the one or more candidate actions.
